(19) United States
(12) Patent Application Publication
(10) Pub. No.: US 2026/0119317 A1
(43) Pub. Date: Apr. 30, 2026

(54) NON-UNIFORM PARITY ALLOCATION IN RANDOM-ACCESS SPATIALLY COUPLED LOW-DENSITY PARITY-CHECK ERROR CORRECTING SCHEMES

(71) Applicant: Micron Technology, Inc., Boise, ID (US)

(72) Inventors: Eyal En Gad, Highland, CA (US); Mariano Eduardo Burich, San Diego, CA (US); Sivagnanam Parthasarathy, Carlsbad, CA (US)

(21) Appl. No.: 18/926,909

(22) Filed: Oct. 25, 2024

(51) Int. Cl. G06F 11/10

(52) U.S. Cl. CPC G06F 11/1068; G06F 11/1004

(57) ABSTRACT

Exemplary methods, apparatuses, and systems including an allocation manager for non-uniform allocation of parity bits. The allocation manager looks up an indication of reliability for a first codeword and an indication of reliability for a second codeword. The allocation manager generates a first joint parity for the first codeword by allocating a first number of parity bits from an available number of parity bits using the indication of reliability for the first codeword. The allocation manager generates a second joint parity for the second codeword by allocating a second number of parity bits from the available number of parity bits using the indication of reliability for the second codeword. The first number of parity bits is different from the second number of parity bits.

### TECHNICAL FIELD

The present disclosure generally relates to random-access spatially coupled error correcting schemes, and more specifically, relates to non-uniform parity allocation in random-access spatially coupled low-density parity-check error correcting schemes.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem, in accordance with some embodiments of the present disclosure.

FIG. 2 illustrates an example allocation manager allocating joint parities in an error correcting scheme, in accordance with some embodiments of the present disclosure.

FIG. 3 is a flow diagram of an example method to perform non-uniform parity bit allocation, in accordance with some embodiments of the present disclosure.

FIG. 4 is a flow diagram of another example method to perform non-uniform parity bit allocation, in accordance with some embodiments of the present disclosure.

FIG. 5 is a block diagram of an example computer system in which embodiments of the present disclosure may operate.

### DETAILED DESCRIPTION

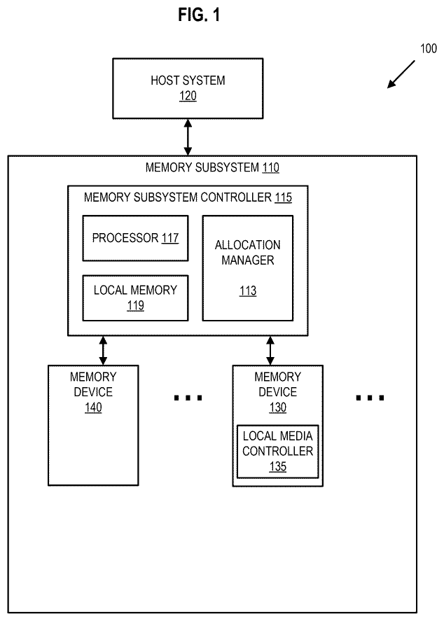

Aspects of the present disclosure are directed to non-uniform parity allocation in an error correcting scheme of a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values.

There are various types of cells, such as single-level cells (SLCs), multi-level cells (MLCs), triple-level cells (TLCs), quad-level cells (QLCs), and penta-level cells (PLCs). For example, an SLC can store one bit of information and has two logic states while a QLC can store sixteen bits of information and has sixteen logic states. Memory cells in a block are addressed using a bitline and a wordline. Pages of a block include a set of memory cells that share a single wordline.

Low-Density Parity Check (LDPC) codes are commonly used for enabling error correction in memory subsystems. LDPC codes are a class of linear block codes with a high error correction capability that involve encoding extra bits (parity bits) into a codeword (e.g., a collection of bits read from a wordline). During decoding, the parity bits are leveraged to correct any changes relative to the data as it was intended to be stored.

A random-access spatially coupled LDPC code is a type of error correcting scheme that involves encoding codewords with different LDPC codes. For example, a base codeword (e.g., a codeword read from a page) can be coupled into a longer global codeword. In a random-access spatially coupled LDPC error correcting scheme, base codewords of the global codeword can be encoded with different LDPC codes. Each base codeword of the global codeword can be decoded individually using the corresponding LDPC code. Further, the LDPC of adjacent codewords (e.g., a pair of codewords or coupled codewords) in the global codeword can be used to decode the pair of codewords. For example, the pair of base codewords in the global codeword can be concatenated and encoded with a number of parity bits to obtain a joint parity. The joint parity is used to decode the pair of adjacent (e.g., coupled) codewords.

In conventional systems, an equal number of parity bits are used to determine the joint parities that couple a pair of base codewords in the global codeword. For example, each base codeword of a global codeword can include 40 k bits that include data and parities. An example memory system may have 8k parity bits available for parity allocation, and a random-access spatially coupled LDPC error correcting scheme can use 16 joint parities to couple 16 base codewords. A conventional system may allocate 8 k/16=500 parity bits for each joint parity used to couple a base codeword. In other words, conventional systems allocate each joint parity a uniform number of parity bits (e.g., 500 parity bits).

Aspects of the present disclosure address the above and other deficiencies by non-uniformly allocating parity bits to joint parities. Parity bits for joint parities can be allocated using a probability of error computed for portions of memory (e.g., pages of a block or codewords obtained from the memory). As a result, joint parities that couple codewords read from unreliable pages (e.g., pages with higher probabilities of error) are allocated a higher number of parity bits. Allocating more parity bits to codewords read from unreliable portions of memory increases the error correction capability of that codeword. Similarly, joint parities that couple codewords read from reliable pages (e.g., pages with relatively lower probabilities of error) are allocated a lower number of parity bits. Accordingly, the error correction capability is improved for portions of memory with higher probabilities of error. Additionally, the total number of parity bits is comparable to conventional solutions because reliable portions of memory use a lower number of parity bits.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory subsystem 110. The host system 120 can further utilize an NVM Express (NVMe) interface to access components (e.g., memory devices 130) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in a local memory 119. In the illustrated example, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processor or controller separate from the memory subsystem 110).

In general, the memory subsystem controller 115 can receive commands or operations from the host system 120 and can convert the commands or operations into instructions or appropriate commands to achieve the desired access to the memory device 130 and/or the memory device 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory subsystem controller 115 can further include host interface circuitry to communicate with the host system 120 via the physical host interface. The host interface circuitry can convert the commands received from the host system into command instructions to access the memory devices 130 and/or the memory device 140 as well as convert responses associated with the memory devices 130 and/or the memory device 140 into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory subsystem controller 115 to execute operations on one or more memory cells of the memory devices 130. An external controller (e.g., memory subsystem controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory subsystem 110 includes an allocation manager 113 that can non-uniformly allocate parity bits for a joint parity using an indication of reliability. In some embodiments, the controller 115 includes at least a portion of the allocation manager 113. For example, the controller 115 can include a processor 117 (processing device) configured to execute instructions stored in local memory 119 for performing the operations described herein. In some embodiments, an allocation manager 113 is part of the host system 120, an application, or an operating system.

The allocation manager 113 allocates a greater number of parity bits to joint parities that couple unreliable codewords in a spatial coupling scheme. Unreliable codewords are codewords with a probability of error and/or a raw bit error rate (RBER) that satisfy an unreliability threshold. For example, the portion of memory from which the codeword was read has a RBER that satisfies the unreliability threshold. The allocation manager 113 allocates a number of parity bits less than the number of parity bits allocated to joint parities coupling unreliable codewords to joint parities coupling reliable codewords (e.g., codewords with RBER that does not satisfy the unreliability threshold/satisfies a reliability threshold). Further details with regards to the operations of the allocation manager 113 are described below.

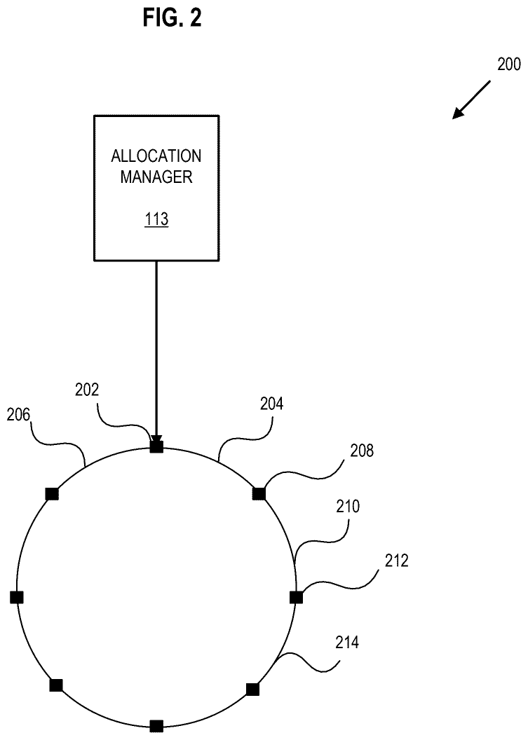

FIG. 2 illustrates an example allocation manager allocating joint parities in an error correcting scheme, in accordance with some embodiments of the present disclosure. As shown in example 200, the allocation manager 113 allocates a number of parity bits from a total number of available parity bits to generate joint parities. For ease of illustration, the allocation manager 113 is illustrated as allocating a number of parity bits to a single joint parity 202, but it should be appreciated that that allocation manager 113 allocates a number of parity bits to each joint parity, represented as black squares in example 200. In example 200, lines between black squares represent codewords and black squares represent joint parities that couple a pair of adjacent codewords. Example 200 illustrates a random-access spatially coupled error correcting scheme (e.g., a low-density parity check error correcting scheme), and particularly, the structure of the random-access spatially coupled error correcting scheme is a tail-biting spatial structure.

In tail-biting spatial coupling, a global codeword is formed by cyclically coupling two adjacent codewords. The black squares visually represent joint parities that couple a pair of codewords (e.g., adjacent codewords) and are used to decode the pair of codewords (i.e., a global codeword) during error correction. As shown in example 200, the allocation manager 113 allocates a number of parity bits for joint parity 202 coupling codeword 204 and codeword 206. The allocation of parity bits depends on an indication of reliability (e.g., a probability of error) of at least one codeword 204 or 206.

In example 200, the allocation manager 113 couples codeword 204 and adjacent codeword 210 in a global codeword and allocates parity bits to the joint parity 208 for the global codeword including codewords 204 and 210. Similarly, the allocation manager 113 couples codeword 214 and adjacent codeword 210 in the global codeword and allocates parity bits to the joint parity 212 for the global codeword including codewords 214 and 210. During error correction, codeword 206 and codeword 204 are error corrected using the joint parity 202. Similarly, codeword 210 and codeword 204 error corrected using the joint parity 208, and codeword 210 and codeword 214 are error corrected using the joint parity 212.

The allocation manager 113 allocates parity bits based on a reliability of base codewords (e.g., codeword 206, codeword 204, codeword 210, codeword 214). In some embodiments, the reliability of base codewords is determined using the RBER of the page (or portion of memory), as determined during a testing period of the memory device 130 and/or memory device 140, from which the codeword is read. For example, the RBER of a first page satisfies an unreliability threshold and the RBER of a second page satisfies the reliability threshold. As a result, the allocation manager 113 determines that codewords read from the first page are unreliable, whereas codewords read from the second page are reliable. In some implementations, the reliability threshold is the inverse of the unreliability threshold (e.g., a codeword satisfies a reliability threshold by failing to satisfy the unreliability threshold). The allocation manager 113 can allocate a first number of bits for joint parities coupling global codewords with reliable codewords, and a second number of bits for joint parities coupling global codewords with one unreliable codeword, where the second number is greater than the first number. In some embodiments, the allocation manager 113 allocates a third number of bits for joint parities coupling global codewords with two unreliable codewords, where the third number of bits is greater than the second number of bits.

In a non-limiting example, codeword 204 is read from the first page and codeword 210 is read from the second page. The allocation manager 113 determines that codeword 204 is an unreliable codeword (by virtue of the first page satisfying the unreliability threshold) and codeword 210 is a reliable codeword (by virtue of the second page satisfying the reliability threshold). As a result, the allocation manager 113 allocates a first number of parity bits from the total available number of parity bits to joint parities coupling codeword 204 (e.g., the unreliable codeword). The first number of parity bits is higher, e.g., than the number of parity bits the allocation manager 113 allocates to a joint parity coupling two reliable codewords. For example, the allocation manager 113 allocates a first number of parity bits to joint parity 208 and joint parity 202 used to couple codeword 204 to codewords 210 and 206 respectively due to the unreliability of codeword 204. The allocation manager 113 encodes codeword 204 and codeword 210 using joint parity 208 and encodes codeword 204 and codeword 206 using joint parity 202. The allocation manager 113 allocates a second number of parity bits from the total available number of parity bits to joint parities coupling reliable codewords (e.g., codewords 210 and 214), where the second number of parity bits is less than the first number of parity bits. For example, the allocation manager 113 allocates a second number of parity bits to joint parity 212 coupling codeword 210 and codeword 214. The allocation manager 113 encodes codeword 210 and codeword 214 using joint parity 212.

Embodiments are not limited to a tail-biting structure and can use other error correcting schemes with spatial coupling. For example, another structure for a random-access spatially coupled error correcting scheme (not shown in example 200) is the terminated spatial coupling structure, in which there are two terminating blocks, each coupled with only one base codeword. The remaining blocks in the terminated spatial coupling scheme are joint parity blocks that are coupled with two adjacent base codewords. Although a terminated spatial coupling structure is distinct from a tail-biting structure, both spatial coupling schemes include overlapping base codewords to form a global codeword. For example, a first codeword is coupled to a second codeword, the second codeword is coupled to a third codeword, the third codeword is coupled to a fourth codeword, and so on. As described herein, the allocation manager 113 can allocate a number of parity bits to joint parities in any spatial coupling error correcting scheme.

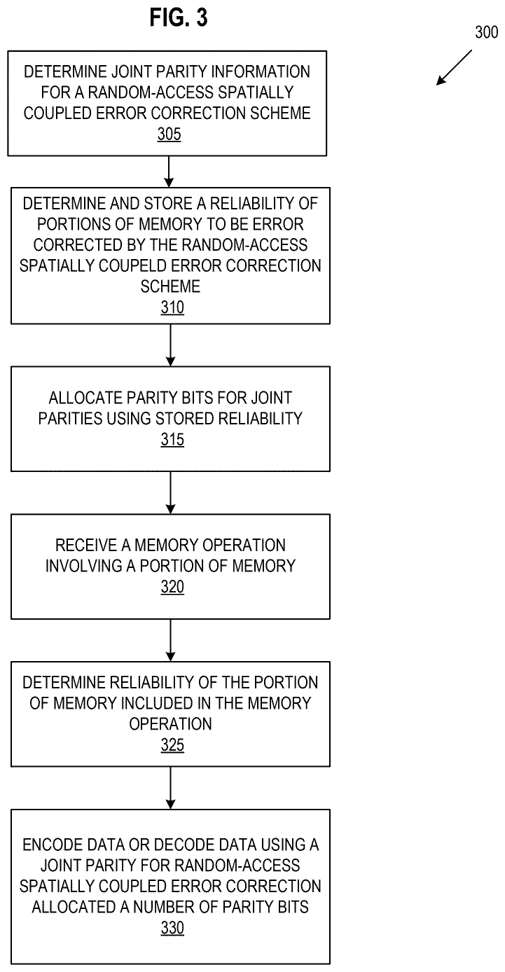

FIG. 3 is a flow diagram of an example method 300 to perform non-uniform parity bit allocation, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the allocation manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing device determines joint parity information for a random-access spatially coupled error correcting scheme. The joint parity information for the random-access spatially coupled error correcting scheme can include a total number of joint parities, representing the number of joint parities used to couple adjacent codewords in the random-access spatially coupled error correcting scheme. The total number of joint parities can be a predetermined value that depends on the random-access spatially coupled error correcting scheme, codeword size, memory size, etc. In some embodiments, the total number of joint parities is a parameter based on the requirements of a particular design or implementation of the memory device or the computing system, for example as the result of experimentation or operational testing.

The joint parity information for the random-access spatially coupled error correcting scheme can also include a number of parity bits available for allocation to joint parities of the random-access spatially coupled error correcting scheme. The number of parity bits available can be a predetermined value that depends on the error correcting scheme, the type/bit density of memory device (e.g., non-volatile memory device 130 or volatile memory device 140), and the like. In some embodiments, the number of parity bits available can be a parameter that is based on the requirements of a particular design or implementation of the memory device or the computing system, for example as the result of experimentation or operational testing.

Examples of random-access spatially coupled error correcting schemes can include a tail-biting error correcting scheme (where global codewords are arranged in a cyclic structure as described herein), a terminated error correcting scheme (where global codewords are arranged in a terminated structure, as described herein), or other structure of a spatial coupling scheme.

In some embodiments, the arrangement of codewords in the global codeword structure of the spatial coupling scheme is predetermined. In other embodiments, the arrangement of codewords in the global codeword structure is determined by the allocation manager 113. For example, the allocation manager 113 couples a reliable codeword (e.g., a codewords read from a portion of memory with an RBER that satisfies the reliability threshold) and an unreliable codeword (e.g., a codeword read from a portion of memory with an RBER that satisfies the unreliability threshold) using a joint parity.

At operation 310, the processing device determines a reliability of portions of memory to be error corrected by the random-access spatially coupled error correction scheme. The reliability of a portion of memory can include the RBER and/or another indication of the probability of error for the portion of memory. The RBER/probability of error for the portion of memory can be the result of experimentation or operational testing. In some embodiments, the reliability of the portion of memory includes the RBER value of one or more codewords obtained from the portion of memory (e.g., codewords read from the portion of memory or codewords written to the portion of memory). The RBER/probability of error for codewords read from the portion of memory can be the result of experimentation or operational testing. As one example, the probability of error for a portion of a memory (and/or the probability of error for codewords) can increase as the memory increases in density (e.g., memory components scale down in size, when multiple bits are programmed per cell, etc.). Additionally, reliability can vary within a given bit density. For instance, a lower page of a TLC can have higher RBER than an extra page.

For each portion of memory to be error corrected by the random-access spatially coupled error correction scheme, the processing device stores the reliability of that portion of memory. For example, three pages of a TLC (e.g., an upper page, a lower page, and an extra page) are to be error corrected using a terminated random-access spatially coupled error correcting scheme. The reliability of the upper page, the lower page, and the extra page of the TLC is determined (e.g., the probability of error for each page of the TLC is experimentally determined) and stored in a reliability table or another data structure that maps the pages of the TLC (e.g., the upper page, the lower page, and the extra page) to the corresponding reliability indicator (e.g., the probability of error determined for that page).

At operation 315, the processing device allocates a number of parity bits for joint parities using the reliability of a portion of memory. In operation, the allocation manager 113 compares reliability indicators (e.g., an RBER or a probability of error) stored in the reliability table to a reliability threshold or an unreliability threshold. As described herein, the reliability threshold is the inverse of the unreliability threshold (e.g., a reliability indicator satisfies a reliability threshold by failing to satisfy the unreliability threshold). The allocation manager 113 flags portions of memory mapped to respective reliability indicators that satisfy the unreliability threshold, indicating portions of unreliable memory. As a result, the allocation manager 113 distinguishes portions of unreliable memory from portions of reliable memory using the reliability table based on whether portions of memory are mapped to reliability indicators that fail or satisfy the unreliability threshold and/or reliability threshold. In some embodiments, the unreliability threshold and/or reliability threshold can be a parameter that is based on the requirements of a particular design or implementation of the memory device or the computing system, for example as the result of experimentation or operational testing.

In some embodiments, the allocation manager 113 allocates a predetermined number of parity bits to joint parities used with unreliable portions of memory. In some embodiments, the allocation manager 113 allocates a different number of parity bits to joint parities used with unreliable portions of memory than the number of parity bits allocated to joint parities used with reliable portions of memory. The number of parity bits allocated to joint parities used with unreliable portions of memory can be a parameter that is based on the requirements of a particular design or implementation of the memory device or the computing system, for example as the result of experimentation or operational testing. Similarly, joint parities used with reliable portions of memory are allocated a predetermined number of parity bits, where the predetermined number of parity bits are a parameter that is based on the requirements of a particular design or implementation of the memory device or the computing system, for example as the result of experimentation or operational testing. In some embodiments, the allocation manager 113 allocates a number of parity bits to joint parities according to RBER values of the codewords obtained from the portions of memory. The number of parity bits allocated to joint parities according to the RBER values of the codewords obtained from the portions of memory can be a parameter that is based on the requirements of a particular design or implementation of the memory device or the computing system, for example as the result of experimentation or operational testing. As described above, the allocation manager 113 can allocate a first number of bits for joint parities coupling global codewords with reliable codewords, a second number of bits for joint parities coupling global codewords with one unreliable codeword, where the second number is greater than the first number, and a third number of bits for joint parities coupling global codewords with two unreliable codewords, where the third number of bits is greater than the second number of bits. In some embodiments, the number of parity bits allocated to joint parities used with each portion of memory is stored in the reliability table. For example, the reliability table maps portions of memory to a number of parity bits allocated for joint parities. In some embodiments, the number of parity bits allocated to joint parities and reliability indicators (e.g., an RBER and/or other indication of a probability of error for a portion of memory) is stored in the reliability table. For example, the reliability table maps the number of parity bits allocated to joint parities and reliability indicators.

The allocation manager 113 increases the capability of random-access spatially coupled error correction schemes by allocating a larger number of parity bits to joint parities mapped to unreliable portions of memory than the number of parity bits allocated to joint parities mapped to reliable portions of memory. By allocating a larger number of parity bits to joint parities mapped to unreliable portions of memory, the allocation manager 113 increases the likelihood that errors associated with the unreliable portion of memory are corrected while minimizing the amount of parity bits used for reliable portions of memory.

At operation 320, the processing device receives a memory operation involving a portion of memory. The memory operation can be a read request or a write request. If the memory operation is a read request, the read request indicates one or more portions of memory directing the processing device to one or more locations/addresses of memory that contain the data to be read. If the memory operation is a write request, the write request identifies data to be written to one or more portions of memory (e.g., one or more logical block addresses).

At operation 325, the processing device determines the reliability of the portion of memory included in the memory operation. For example, the allocation manager 113 can map the portion of memory indicated in the memory operation to a portion of memory stored in the reliability table, e.g., using the address of the portion of memory. Using the table, the allocation manager 113 maps the portion of memory to a reliability indicator and/or a number of parity bits allocated for joint parities mapped to the portion of memory (as described with reference to operation 315).

At operation 330, the processing device encodes data or decodes data for random-access spatially coupled error correction using a joint parity allocated a number of parity bits. For example, if the memory operation described in operation 320 is a write operation, the allocation manager 113 generates a joint parity used to encode the data in the write operation for random-access spatially coupled error correction. In operation, the allocation manager 113 maps the portion of memory included in the write operation to an allocated number of parity bits (as described at operation 315) determined using the reliability table.

The allocation manager 113 then generates a joint parity using the allocated number of parity bits and encodes the data using the joint parity. If the memory operation described in operation 320 is a read operation, the allocation manager 113 uses a joint parity to decode the data in the read operation for random-access spatially coupled error correction. For example, the allocation manager 113 indicates the allocated number of parity bits for the decoder to enable the decoder to decode global codewords having varying numbers of joint parity bits.

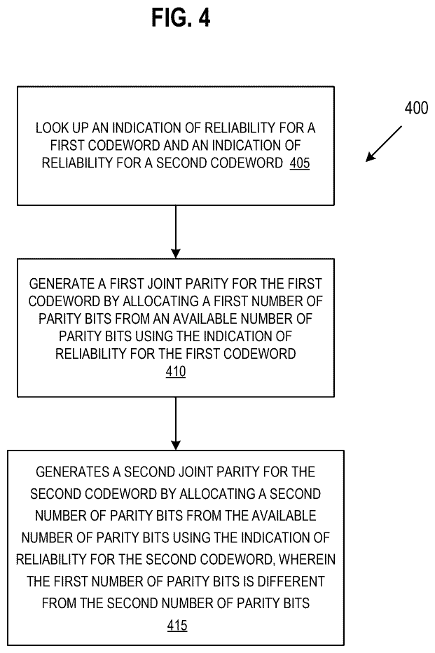

FIG. 4 is a flow diagram of an example method 400 to non-uniformly allocate parity bits for a joint parity in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the allocation manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device looks up an indication of reliability for a first codeword and an indication of reliability for a second codeword. As described with reference to operation 325 of FIG. 3, the allocation manager 113 looks up a reliability of portions of memory which can include an RBER and/or a probability of error for a portion of memory to which a codeword is to be written. In some embodiments, the allocation manager 113 looks up the number of parity bits allocated to joint parities mapped to portions of to which the codeword is to be written. In some embodiments, the allocation manager 113 looks up the number of parity bits allocated to joint parities mapped to a reliability indicator determined for the portion of memory to which the codeword is to be written.

At operation 410, the processing device generates a first joint parity for the first codeword by allocating a first number of parity bits from an available number of parity bits using the indication of reliability for the first codeword. As described with reference to operation 315 of FIG. 3, the allocation manager 113 allocates a greater number of parity bits from the available number of parity bits for joint parities coupling one or more unreliable codewords (e.g., codewords read from and/or written to portions of memory with an RBER and/or a probability of error that satisfies unreliability threshold) than joint parities coupling reliable codewords.

At operation 415, the processing device generates a second joint parity for the second codeword by allocating a second number of parity bits from the available number of parity bits using the indication of reliability for the second codeword. The first number of parity bits is different from the second number of parity bits. As described with reference to operation 315 of FIG. 3, the allocation manager 113 allocates a different number of parity bits to the second joint parity than the number of parity bits allocated to the first joint parity responsive to an indication of reliability. Similar to the examples discussed above, the indication of reliability for the first codeword can dictate the number of parity bits allocated for the second codeword. For example, the allocation manager 113 allocates a fewer number of parity bits to the second joint parity than the first joint parity by virtue of the second codeword having a greater indication of reliability than the first codeword.

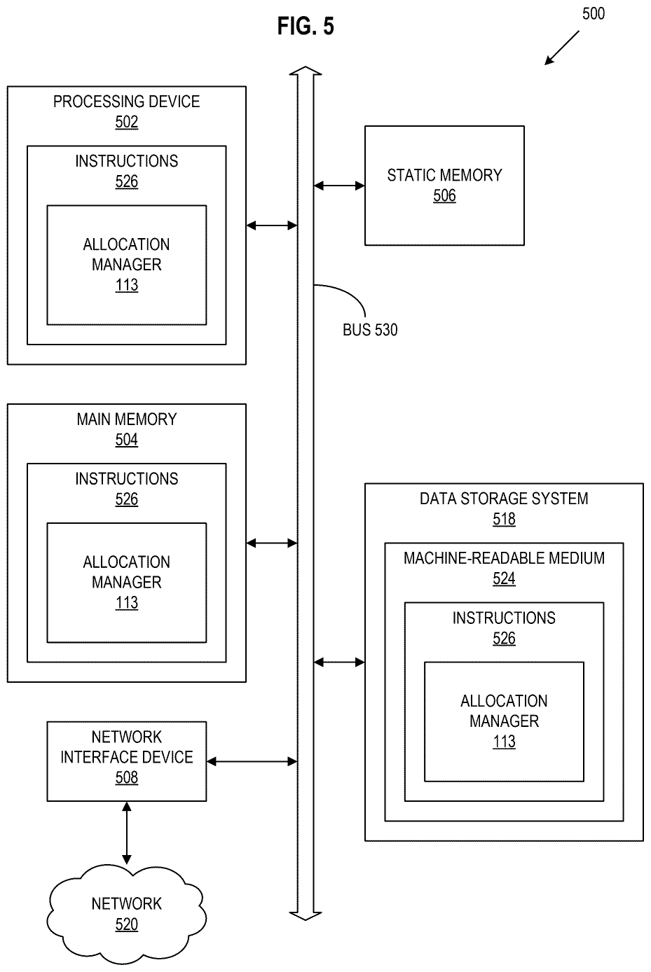

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the allocation manager 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory subsystem 110 of FIG. 1.

In one embodiment, the instructions 526 include instructions to implement functionality corresponding to an allocation manager (e.g., the allocation manager 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the memory subsystem controller 115, may carry out the computer-implemented methods 300 and/or 400 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
looking up an indication of reliability for a first codeword and an indication of reliability for a second codeword;
generating a first joint parity for the first codeword by allocating a first number of parity bits from an available number of parity bits using the indication of reliability for the first codeword; and
generating a second joint parity for the second codeword by allocating a second number of parity bits from the available number of parity bits using the indication of reliability for the second codeword, wherein the first number of parity bits is different from the second number of parity bits.

2. The method of claim 1, wherein the first joint parity couples the first codeword and an adjacent third codeword in a global codeword, and wherein the second joint parity couples the second codeword and an adjacent fourth codeword in the global codeword.

3. The method of claim 2, further comprising:
encoding the first codeword and the adjacent third codeword using the first joint parity; and
encoding the second codeword and the adjacent fourth codeword using the second joint parity.

4. The method of claim 2, wherein the first codeword is read from a first page and the second codeword is read from a second page, wherein a raw bit error rate (RBER) of the first page is higher than the RBER of the second page.

5. The method of claim 4, wherein the first number of parity bits for the first joint parity are higher than the second number of parity bits for the second joint parity based on the RBER of the first page being higher than the RBER of the second page.

6. The method of claim 1, wherein the first joint parity and the second joint parity are for a random-access spatially coupled low-density parity check error correcting scheme.

7. The method of claim 6, wherein a structure of the random-access spatially coupled low-density parity check error correcting scheme is a tail-biting structure or a terminated structure.

8. A non-transitory computer-readable storage medium comprising instructions that, when executed by a processing device, cause the processing device to:
look up an indication of reliability for a first codeword and an indication of reliability for a second codeword;
generate a first joint parity for the first codeword by allocating a first number of parity bits from an available number of parity bits using the indication of reliability for the first codeword; and
generate a second joint parity for the second codeword by allocating a second number of parity bits from the available number of parity bits using the indication of reliability for the second codeword, wherein the first number of parity bits is different from the second number of parity bits.

9. The non-transitory computer-readable storage medium of claim 8, wherein the first joint parity couples the first codeword and an adjacent third codeword in a global codeword, and wherein the second joint parity couples the second codeword and an adjacent fourth codeword in the global codeword.

10. The non-transitory computer-readable storage medium of claim 9, wherein the processing device is further to:
encode the first codeword and the adjacent third codeword using the first joint parity; and
encode the second codeword and the adjacent fourth codeword using the second joint parity.

11. The non-transitory computer-readable storage medium of claim 9, wherein the first codeword is read from a first page and the second codeword is read from a second page, wherein a raw bit error rate (RBER) of the first page is higher than the RBER of the second page.

12. The non-transitory computer-readable storage medium of claim 11, wherein the first number of parity bits for the first joint parity are higher than the second number of parity bits for the second joint parity based on the RBER of the first page being higher than the RBER of the second page.

13. The non-transitory computer-readable storage medium of claim 8, wherein the first joint parity and the second joint parity are for a random-access spatially coupled low-density parity check error correcting scheme.

14. The non-transitory computer-readable storage medium of claim 13, wherein a structure of the random-access spatially coupled low-density parity check error correcting scheme is a tail-biting structure or a terminated structure.

15. A system comprising:
a plurality of memory devices; and
a processing device, operatively coupled with the plurality of memory devices, to:
look up an indication of reliability for a first codeword and an indication of reliability for a second codeword;
generate a first joint parity for the first codeword by allocating a first number of parity bits from an available number of parity bits using the indication of reliability for the first codeword; and
generate a second joint parity for the second codeword by allocating a second number of parity bits from the available number of parity bits using the indication of reliability for the second codeword, wherein the first number of parity bits is different from the second number of parity bits, and wherein the first joint parity couples the first codeword and an adjacent third codeword in a global codeword, and wherein the second joint parity couples the second codeword and an adjacent fourth codeword in the global codeword.

16. The system of claim 15, wherein the processing device is further to:
encode the first codeword and the adjacent third codeword using the first joint parity; and
encode the second codeword and the adjacent fourth codeword using the second joint parity.

17. The system of claim 15, wherein the first codeword is read from a first page and the second codeword is read from a second page, wherein a raw bit error rate (RBER) of the first page is higher than the RBER of the second page.

18. The system of claim 17, wherein the first number of parity bits for the first joint parity are higher than the second number of parity bits for the second joint parity based on the RBER of the first page being higher than the RBER of the second page.

19. The system of claim 15, wherein the first joint parity and the second joint parity are for a random-access spatially coupled low-density parity check error correcting scheme.

20. The system of claim 19, wherein a structure of the random-access spatially coupled low-density parity check error correcting scheme is a tail-biting structure or a terminated structure.
